(19) United States
(12) Patent Application Publication
(10) Pub. No.: US 2008/0055895 A1
(43) Pub. Date: Mar. 6, 2008

(54) Backlight Module

(75) Inventors: Yi Jing Wang, Hsinchu (TW); Yichun Lin, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 11/696,868

(22) Filed: Apr. 5, 2007

(30) Foreign Application Priority Data
Sep. 5, 2006 (TW) 95132688

(51) Int. Cl. F21S 4/00

(52) U.S. Cl. 362/225; 362/253; 362/296

(57) ABSTRACT

A backlight module is provided. The backlight module comprises a light source and a back bezel. The light source includes at least one high voltage electrode terminal. The back bezel is positioned at a rear portion of the light source. The back bezel is formed with at least an opening at a lower portion thereof. At least a part of the opening faces a rear portion of the high voltage electrode terminal. The back bezel is capable of changing the temperature distribution of the light source to allow more lamps operate under a better working temperature, thereby stabilizing the operational quality of the backlight module and prolonging its service life.

This application claims priority to Taiwan Patent Application No. 095132688 filed on Sep. 5, 2006, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a backlight module. More particularly, the present invention relates to a backlight module with little current leakage and with a greater portion of light source within a certain temperature range to enhance performance.

2. Descriptions of the Related Art

Liquid Crystal Display (LCD) technologies have developed rapidly in recent years. Consequently, many electronic devices, such as Personal Digital Assistants (PDAs), laptops, digital cameras, mobile phones, computer monitors, and LCD TVs, comprise LCD panels. To display images, an LCD uses the light source from a backlight module. Thus, the quality of an LCD is directly related to the quality of the light source from the backlight module.

According to the position of the light source, backlight modules are categorized into two types: edge types and direct types. Lamps of an edge-type backlight module are equipped on the sides of the LCD panel. The light emitted by the lamps is transmitted to the light guiding panel equipped behind the LCD panel. Then, using the light guiding panel as a medium, incident lights are guided into the light guiding panel for reflection and refraction.

The direct-type backlight module comprises a back bezel, a reflection panel, a plurality of lamps, a diffusion plate, and optical films. The back bezel forms a container holding the reflection panel. The lamps are arranged in front of the reflection panel inside the container. The diffusion panel and the optical films are disposed in front of the lamps, wherein the optical films comprise a prism sheet, a diffuser, and a brightness enhancement film. The LCD panel is disposed in front of the optical films.

In the direct-type backlight module, drivers are required for supplying the high voltages to the two electrode terminals. For example, drivers provide +1 KV and −1 KV to the two electrode terminals, respectively, to provide the proper current for lighting. The emitted light processed by the reflection panel, diffusion plate, and optical films are then projected onto the LCD.

Because the back bezel is usually made of conducted metal, parasitic capacitance or stray capacitance is usually generated between the electrode terminals and the back bezel when high voltage is supplied to the lamp. Unfortunately, the currents supplied to the lamps by the drivers leak to the back bezel, which greatly reduces the lighting performance. Since the received current is less than the expected current, the lighting performance of the back bezel degrades. In addition, because hot air rises, the lamps disposed at the upper portion of the backlight module are further affected by high temperature. As a result of the large temperature gap between the upper and lower areas of the backlight module, the lighting performance is further reduced, shortening the life of the lamps.

According to the aforementioned descriptions, a method that reduces the leakage current of a direct-type backlight module and to change the temperature distribution of lamps to increase lighting performance and lifetimes of lamps is still a critical industrial issue.

### SUMMARY OF THE INVENTION

An object of the present invention is to provide a backlight module. The backlight module comprises a light source and a back bezel. The light source includes a high-voltage electrode terminal formed at one end thereof. The back bezel is positioned behind the light source. The back bezel is provided with an opening formed at a lower portion of the back bezel, in which the opening is formed to face at least part of the first high-voltage electrode terminal.

Another object of the present invention is to provide a backlight module that comprises a plurality of linear light source units and a back bezel. The linear light source units are arranged substantially in parallel to one another. Each of the linear light source units has a first high-voltage electrode terminal formed at one end thereof. The back bezel is positioned behind the linear light source units and is provided with a first opening formed at a lower portion of the back bezel. The first opening faces at least part of the first high-voltage electrode terminals.

Another object of the present invention is to provide a backlight module. The backlight module comprises a light source and a back bezel. The light source includes a first high-voltage electrode terminal that corresponds to a predetermined range of preferred operating temperature. The predetermined range has a lower-bound temperature, usually between 65° C. to 75° C. The first high-voltage electrode terminal has an actual operating temperature lower than the lower-bound temperature. The back bezel is disposed behind the light source. The back bezel has a first portion which is formed with an opening to face at least part of the first high-voltage electrode terminal.

A further object of the present invention is to provide a backlight module that comprises a plurality of linear light source units and a back bezel. The linear light source units are arranged substantially in parallel to one another and correspond to a predetermined range of preferred operating temperature. The predetermined range has a lower-bound temperature. Each of the linear light source units has a first high-voltage electrode terminal formed at one end thereof. At least one of the first high-voltage electrode terminal has an actual operating temperature lower than the lower-bound temperature. The back bezel is disposed behind the light source. The back bezel has a first portion which is formed with a first opening to face at least part of the first high-voltage electrode terminal that has an actual operating temperature lower than the lower-bound temperature.

With the aforementioned arrangement, the present invention is capable of reducing the parasitic capacitance and the leakage current of a specific lower portion of the back bezel. At the same time, the lighting performance and the temperature of the light sources at the specific portion are increased accordingly. Thus, more lamps operate in the range of the preferred operating temperatures. Temperature distribution of the lamps is more evenly. With temperature of the lamps being evenly distributed, the backlight module has better quality and a longer lifetime.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A illustrates a side view of the relationship between the lamps and the back bezel of the first embodiment;

FIG. 1B illustrates a front view of the first embodiment;

FIG. 1C illustrates a back view of the first embodiment;

FIG. 2 illustrates a back view of a second embodiment;

FIG. 3 illustrates the distribution of the lamp temperatures; and

FIG. 4 illustrates the comparison between the lamp temperatures of a back bezel with openings to a back bezel without openings.

### DESCRIPTION OF THE PREFERRED EMBODIMENT

The principle of the present invention is to control the amount of current leakage from part of the lamps of a backlight module so that more lamps operate in a predetermined range of a preferred operating temperature and the distribution of the lamp temperatures is more uniform. In addition, the brightness of the backlight module is increased and distributed more evenly.

The relationship between current leakage and parasitic capacitance can be expressed with the following equation:

I_{S}=2πf*C_{S}*V_{L},

wherein I_{S} represents the value of the current leakage, C_{S} represents the values of the parasitic capacitance, f represents the frequency of the alternating voltage provided by a lamp driver to a high voltage electrode terminal of a light source, and V_{L} represents a voltage value supplied to the high voltage electrode terminal of the light source of the lamp driver. According to the above equation, I_{S} is proportional to f, C_{S}, and V_{L}. Thus, decreasing the frequency of the alternating voltage f, the parasitic capacitance C_{S}, the voltage V_{L} or a combination thereof can decrease current leakage, I_{S}.

Decreasing current leakage, I_{S}, by decreasing the frequency of the alternating voltage, f, requires to adjust the LCD, to avoid display distortion. Decreasing current leakage, I_{S}, by reducing the voltage V_{L} faces an obstacle. That is, the voltage V_{L} relates to the size of a light source. A longer or thinner light source requires a higher voltage V_{L}. However, light source sizes are limited, so reducing the voltage V_{L} requires new light sources, adding cost. As a result, reducing current leakage by reducing the parasitic capacitance is a more efficient approach. The factors that affect the parasitic capacitance C_{S} between a high voltage electrode terminal and a back bezel include the following: the dielectric parameter ε of the material between the high voltage electrode of the light source and the back bezel, the size of the overlapped area S between the high voltage electrode of the light source and the back bezel, and the distance d between the high voltage electrode of the light source and the back bezel. These relationships can be represented by the following equation:

Cs=ε*S/d.

According to the above equation, Cs is proportional to ε and S and inversely proportional to d. Thus, reducing current leakage I_{S} by reducing C_{S} requires the reduction of the overlapped area S or the increase of the distance d. However, increasing the distance d would increase the volume of the backlight module, which does not produce thinner or smaller LCDs. Consequently, the present invention reduces the overlapped area S to reduce current leakage I_{S}. The reduction of the overlapped area S is achieved by forming openings in the back bezel which correspond to the high voltage electrode terminals of the lamps with insufficient temperatures.

Because hot air rises, the lamps disposed in the upper portions of the back bezel have higher temperatures. In contrast, lamps disposed in the lower portions of the back bezel often have temperatures lower than the required temperatures. To make the hot air flow to lower temperature regions, openings are often formed at the lower portion of the back bezel, which corresponds to lamps with insufficient temperatures Thus, the air flow to the cooler region of the back bezel distributes the temperatures between the portions more evenly.

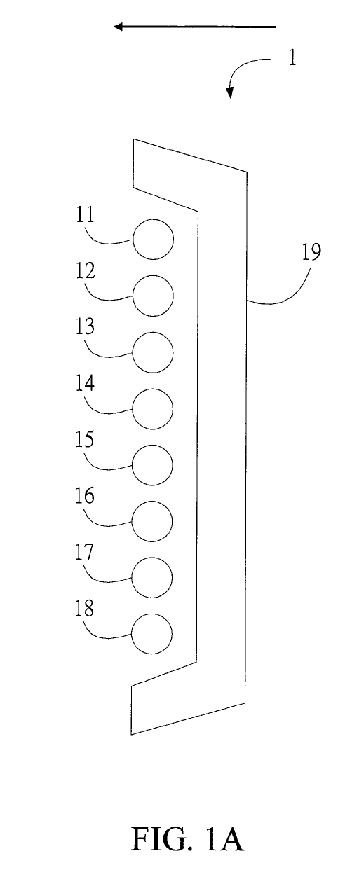

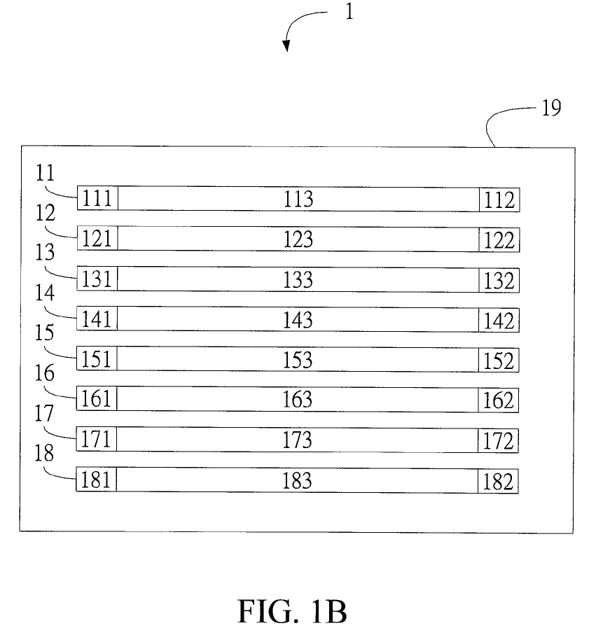

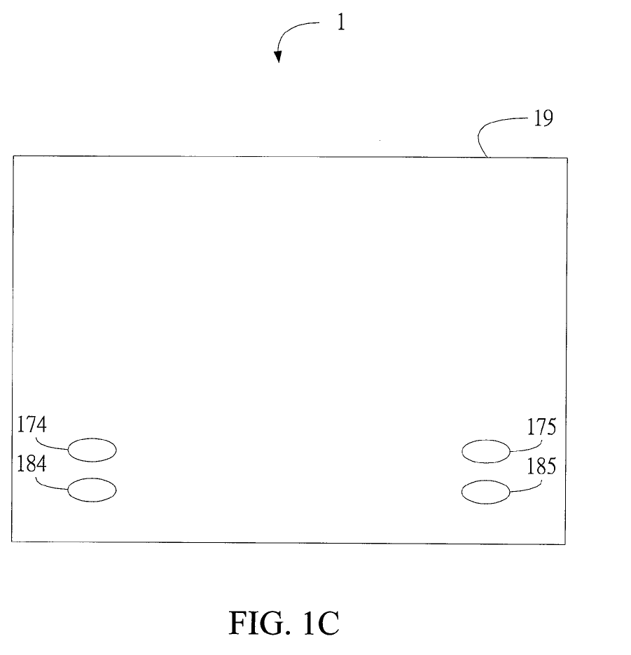

FIG. 1A illustrates a side view of a first embodiment of the present invention, which is a backlight module 1. The backlight module 1 comprises eight Cold Cathode Fluorescent Lamps (CCFLs) 11-18 and a back bezel 19. The eight CCFLs are disposed in front of the back bezel 19 (the arrow points to the front).

FIG. 1B illustrates a front view of the first embodiment. Each CCFL comprises three parts: a first high voltage electrode terminal, a second high voltage electrode terminal, and a light source unit. That is, the first CCFL 11 comprises a first high voltage electrode terminal 111, a second high voltage electrode terminal 112, and a light source unit 113. The second CCFL 12 comprises a first high voltage electrode terminal 121, a second high voltage electrode terminal 122, and a light source unit 123. The third CCFL 13 comprises a first high voltage electrode terminal 131, a second high voltage electrode terminal 132, and a light source unit 133. The fourth CCFL 14 comprises a first high voltage electrode terminal 141, a second high voltage electrode terminal 142, and a light source unit 143. The fifth CCFL 15 comprises a first high voltage electrode terminal 151, a second high voltage electrode terminal 152, and a light source unit 153. The sixth CCFL 16 comprises a first high voltage electrode terminal 161, a second high voltage electrode terminal 162, and a light source unit 163. The seventh CCFL 17 comprises a first high voltage electrode terminal 171, a second high voltage electrode terminal 172, and a light source unit 173. The eighth CCFL 18 comprises a first high voltage electrode terminal 181, a second high voltage electrode terminal 182, and a light source unit 183.

FIG. 1C illustrates a back view of the first embodiment. The lower portion of the back bezel 19 comprises two first openings 175, 185 and two second openings 174, 184. The first opening 175 corresponds to the first high voltage electrode terminal 171 of the seventh CCFL 17 and the first opening 185 corresponds to the first high voltage electrode terminal 181 of the eighth CCFL 18. Similarly, the second opening 174 corresponds to the second high voltage electrode terminal 172 of the seventh CCFL 17 while the second opening 184 corresponds to the second high voltage electrode terminal 182 of the eighth CCFL 18. Since the shapes of the first openings 175, 185 and two second openings 174, 184 are oval-shaped, they partially correspond to the first high voltage electrode terminal and the second high voltage electrode terminals.

The aforementioned openings are formed at the lower portion of the back bezel, which shows that the overlapped area S between the high-voltage electrode terminals of light sources and the back bezel is reduced. Thus, the parasitic capacitance C_{S} and the current leakage I_{S} between the back bezel and the high voltage electrode terminals of the light sources are reduced. The lighting performance of the light sources is consequently increased. Furthermore, the lighting quality of the lower portion of the back bezel is increased and the distribution of the light source temperatures in the upper and lower portion is more even. As a result, the lamp life is increased.

The shapes, sizes, numbers, and positions of the first openings and the second openings are not limited by the aforementioned description. The only requirement is for the first and second openings formed in the lower portion of the back bezel 19 to face the rear of the high voltage electrode terminals. An opening can be formed completely or partially behind the high voltage electrode terminal.

In addition, the aforementioned 8 CCFLs can be replaced with External Electrode Fluorescent Lamps (EEFLs) or any other fluorescent lamps that require a driver. Further, the CCFLs can be replaced by a Cold Cathode Flat Fluorescent Lamp (CCFFL) or any other flat fluorescent lamps that require a driver.

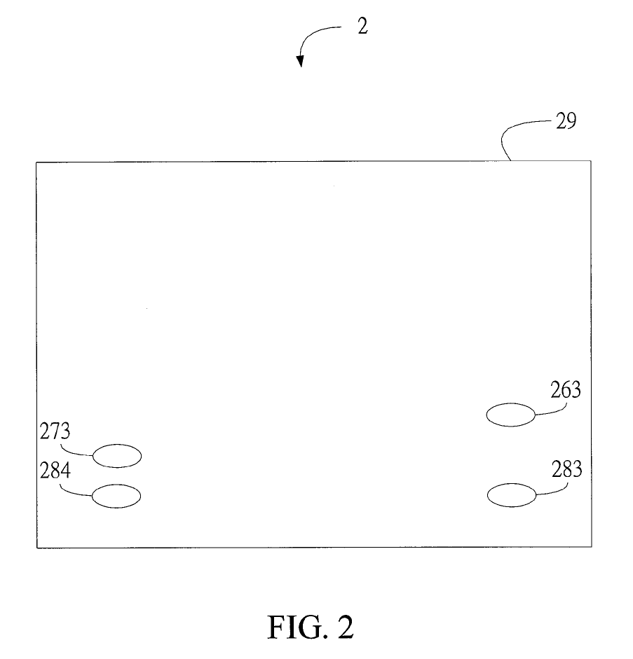

FIG. 2 illustrates a back view of a second embodiment of the present invention, which is a backlight module 2. The backlight module 2 comprises 8 CCFLs (not shown) and a back bezel 29. The back bezel 29 comprises two first openings 263, 283 and two second openings 273, 284, that correspond to the first high voltage electrode terminals of two CCFLs and the second high voltage electrode terminals of two other CCFLs, respectively, wherein the first opening 283 and the second opening 284 correspond to the same CCFL.

Similarly, the shapes, sizes, numbers, and positions of the first openings and the second openings are not limited to the aforementioned description. The only requirement is for the first and second openings formed at the lower portion of the back bezel 29 to face the high voltage electrode terminals so that current leakage I_{S} is reduced. The first and second opening can partially or completely face the first and second high voltage electrode terminals. In addition, the CCFLs can be replaced by EEFLs, CCFFLs, or any other fluorescent lamps that require a driver.

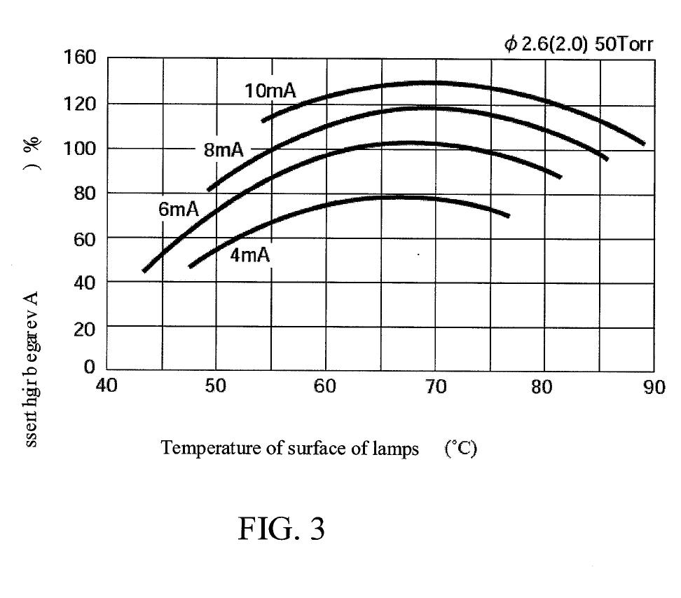

FIG. 3 illustrates the distribution of the lamp temperatures, wherein the horizontal axis represents the lamp temperatures and the vertical axis represents relative brightness. The four curves represent the lamp currents set at 4 mA, 6 mA, 8 mA, and 10 mA, respectively. From FIG. 3, it is obvious that the range of preferred operating temperatures, i.e. to achieve the best relative brightness, is between 65° C. and 75° C. That is, in this range, the relative brightness of lamps is highest and evenly distributed. Since the object of the present invention is to increase the lighting performance and the life of the lamps, more lamps with actual operating temperatures in the range of the preferred operating temperatures are required. Thus, regardless of the lamp diameters, if more lamps operate between 65° C. and 75° C., the lighting performance will be increased, thermal energy will be diffused more evenly, and the lifetime of the lamps will be increased.

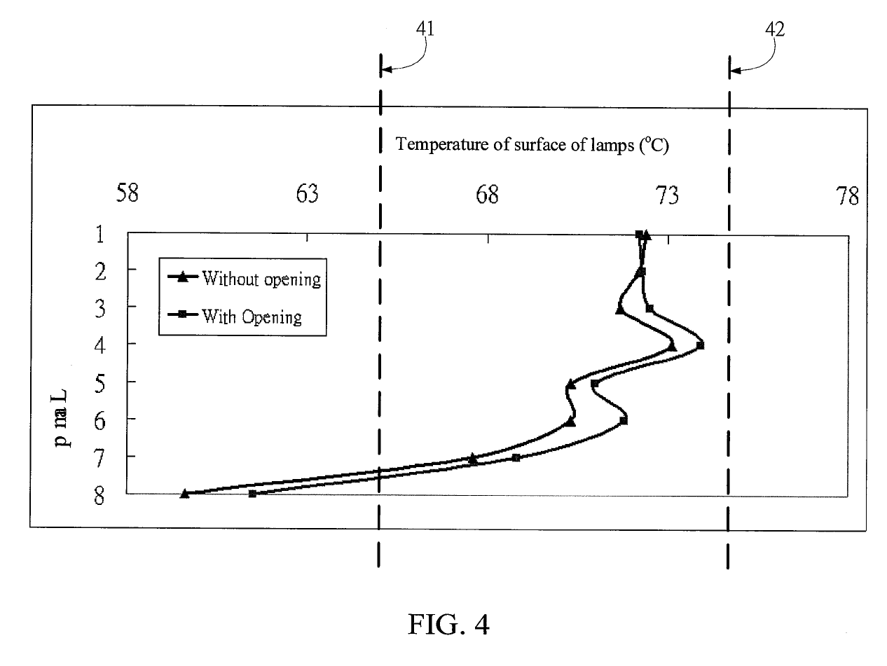

FIG. 4 shows a comparison between the surface temperatures of the lamps corresponding to a back bezel with openings and a back bezel without openings, wherein the horizontal axis represents the temperature of the surfaces of the lamps and the vertical axis represents the relative upper positions and lower positions of the back bezel. Specifically, because each of the two backlight module comprises 16 CCFLs, the number on the vertical axis corresponds to the positions of every two CCFLs. Furthermore, the back bezel with openings has eight openings facing the two high voltage electrode terminals of each of the lowest four CCFLs.

In FIG. 4, the curve with triangles represents the back bezel without openings, while the curve with rectangles represents the back bezel with openings. The dotted lines 41, 42 show that the surface temperatures of the lamps are around 65° C. and 75° C., respectively.

According to FIG. 4, the surface temperatures of the lamps in the back bezel with openings are higher than those in the back bezel without openings. The average temperature from the first point to the fourth point increases about 0.4° C., while the average temperature from the fifth dot to the eight dot increases about 1.4° C. As shown in this figure, more lamps will operate normally, or more specifically, in the range of preferred operating temperatures, in the back bezel with openings. Furthermore, the differences between the temperatures of the lamps in the lower and upper portion are reduced. As a result, the distribution of the temperatures of the lamps is more uniform. This statement is supported by the fact that the curve between 65° C. to 75° C. of the back bezel with opening is longer than that of back bezel without opening. Furthermore, the lifetime of the lamps are prolonged.

In addition to the temperatures, the brightness values of the lamps are described in the following tables. Table 1 and Table 2 show the average brightness values of the light sources of the back bezels without opening and with openings, respectively. The experimental conditions are similar to those conditions set in deriving the results drawn in FIG. 4. Each of the tables comprises 81 numbers and each of the numbers corresponds to a position on the back bezel of the backlight module. For example, the number 5712 of Table 1 corresponds to the left-upper position of the back bezel. Other numbers in Table 1 and Table 2 are interpreted using a similar approach.

In Table 1, the average brightness value from the first row to the fourth row is 6447 nit, while the average brightness value from the sixth row to the ninth row is 6175 nit. In Table 2, the average brightness value from the first row to the fourth row is 6450 nit, while the average brightness value from the sixth row to the ninth row is 6222 nit. From the numbers, it is obvious that the average brightness value of a back bezel with openings is higher than that of a back bezel without openings. In addition, the increased value in the lower portion of the back bezel is even more convincing. The values also show that when a back bezel has openings in its lower portion, the brightness values of the upper portion and of the lower portions are closer in values. Thus, the back bezel is in a better state and the lifetime of the back bezel is increased.

TABLE 1
Average brightness of the back bezel without opening (Nit)

| | | | | | | | | |
|---|---|---|---|---|---|---|---|---|
| 5712 | 6101 | 6218 | 6240 | 6241 | 6255 | 6035 | 6101 | 5722 |
| 6040 | 6430 | 6560 | 6575 | 6611 | 6576 | 6426 | 6362 | 5992 |
| 6250 | 6620 | 6718 | 6673 | 6836 | 6815 | 6744 | 6583 | 6217 |
| 6408 | 6761 | 6842 | 6770 | 6937 | 6928 | 6842 | 6663 | 6286 |
| 6345 | 6732 | 6763 | 6783 | 6843 | 6798 | 6688 | 6628 | 6248 |
| 6303 | 6654 | 6744 | 6731 | 6779 | 6770 | 6495 | 6512 | 6149 |
| 6154 | 6533 | 6604 | 6613 | 6636 | 6628 | 6400 | 6299 | 5972 |
| 5837 | 6163 | 6245 | 6213 | 6308 | 6321 | 6214 | 6060 | 5661 |
| 5330 | 5658 | 5701 | 5627 | 5769 | 5774 | 5722 | 5540 | 5163 |

TABLE 2
Average brightness of the back bezel with opening at its lower portion
(Nit)

| | | | | | | | | |
|---|---|---|---|---|---|---|---|---|
| 5704 | 6100 | 6215 | 6233 | 6249 | 6254 | 6047 | 6105 | 5716 |
| 6035 | 6432 | 6551 | 6580 | 6609 | 6579 | 6426 | 6355 | 5991 |
| 6251 | 6642 | 6736 | 6687 | 6844 | 6816 | 6743 | 6584 | 6217 |
| 6402 | 6780 | 6850 | 6792 | 6948 | 6939 | 6842 | 6660 | 6276 |
| 6363 | 6746 | 6790 | 6801 | 6862 | 6803 | 6697 | 6610 | 6263 |
| 6332 | 6714 | 6795 | 6777 | 6827 | 6802 | 6530 | 6535 | 6182 |
| 6209 | 6591 | 6655 | 6652 | 6682 | 6664 | 6431 | 6320 | 5991 |
| 5923 | 6245 | 6336 | 6264 | 6361 | 6366 | 6258 | 6095 | 5692 |
| 5431 | 5747 | 5766 | 5685 | 5817 | 5810 | 5760 | 5570 | 5188 |

From the aforementioned descriptions, the formation of openings at the lower portion of the back bezel reduces current leakage and parasitic capacitance and increases temperatures. The principle behind choosing opening positions is to choose positions that can reduce the area of the back bezel behind the high voltage electrode terminal. When there is almost no metal behind the high voltage electrode terminal, the parasitic capacitance at the electrode is almost zero. According to other experiments, this method increases the lamp temperature about 5° C. to 7° C. Thus, the lighting performance of the light source is increased, while the voltage provided to the light source by the light driver becomes more stable. Furthermore, part of the hot air flows to the openings and increases the temperatures of the corresponding lamps which makes the temperatures and brightness values of the upper and lower portions be more uniform. In summary, it is more beneficial to have openings in the lower portion of the back bezel as compared to a back bezel without openings, openings in the upper portion or openings along the whole back bezel.

The above disclosure is related to the detailed technical contents of the present invention and inventive features thereof. People skilled in this field may proceed with a variety of modifications and replacements based on the teachings and suggestions of the invention as described without departing from the characteristics thereof. Nevertheless, although such modifications and replacements are not fully disclosed in the above descriptions, they have substantially been covered in the following claims as appended.

What is claimed is:

1. A backlight module, comprising:
a light source including a first high-voltage electrode terminal formed at one end thereof; and
a back bezel positioned behind the light source and provided with a first opening which is formed at a lower portion of the back bezel, in which the first opening faces at least part of the first high-voltage electrode terminal.

2. The backlight module of claim 1, wherein the light source further includes a second high-voltage electrode terminal formed at the other end thereof, the back bezel includes a second opening formed at the lower portion thereof, in which the second opening faces at least part of the second high-voltage electrode terminal.

3. The backlight module of claim 1, further comprising a reflective unit, wherein the back bezel is defined by a central portion and at least one peripheral portion, the first high-voltage electrode terminal faces the at least one peripheral portion, and the reflective unit is disposed between the light source and the central portion of the back bezel.

4. A backlight module comprising:
a plurality of linear light source units arranged substantially in parallel to one another, each of the linear light source units having a first high-voltage electrode terminal formed at one end thereof; and
a back bezel positioned behind the linear light source units and provided with a first opening which is formed at a lower portion of the back bezel, wherein the first opening faces at least part of the first high-voltage electrode terminals.

5. The backlight module of claim 4, wherein each of the linear light source units further has a second high-voltage electrode terminal formed at the other end thereof, the back bezel includes a plurality of first openings and a plurality of second openings, in which the first openings are formed to face at least part of the first high-voltage electrode terminals, and the second openings are formed to face at least part of the second high-voltage electrode terminals.

6. The backlight module of claim 4, wherein the back bezel includes a plurality of first openings and a plurality of second openings, in which the first openings are formed to completely face the first high-voltage electrode terminals, and the second openings are formed to completely face the second high-voltage electrode terminals.

7. The backlight module of claim 4, wherein at least one of the linear light source units is an External Electrode Fluorescent Lamp (EEFL).

8. The backlight module of claim 4, wherein at least one of the linear light source units is a Cold Cathode Fluorescent Lamp (CCFL).

9. The backlight module of claim 4, wherein at least one of the linear light source units is a flat linear light source.

10. The backlight module of claim 9, wherein the flat linear light source is a Cold Cathode Flat Fluorescent Lamp (CCFFL).

11. A backlight module, comprising:
a light source including a first high-voltage electrode terminal, corresponding to a predetermined range of preferred operating temperature, the predetermined range having a lower-bound temperature, and the first high-voltage electrode terminal having an actual operating temperature lower than the lower-bound temperature; and
a back bezel, disposed behind the light source, the back bezel having a first portion which is formed with a first opening to face at least part of the first high-voltage electrode terminal.

12. The backlight module of claim 11, wherein the light source further includes a second high-voltage electrode terminal formed at the other end thereof, the back bezel has a second portion which includes a second opening to face at least part of the second high-voltage electrode terminal, and the second high-voltage electrode terminal has an actual operating temperature which is lower than the lower-bound temperature.

13. The backlight module of claim 11, further comprising a reflective unit, wherein the back bezel is defined by a central portion and at least one peripheral portion, the first high-voltage electrode terminal faces the at least one peripheral portion, and the reflective unit is disposed between the light source and the central portion of the back bezel.

14. A backlight module comprising:
a plurality of linear light source units, which are arranged substantially in parallel to one another and correspond to a predetermined range of preferred operating temperature, the predetermined range having a lower-bound temperature, each of the linear light source units having a first high-voltage electrode terminal formed at one end thereof, and at least one of the first high-voltage electrode terminal having an actual operating temperature lower than the lower-bound temperature; and
a back bezel, disposed behind the light source, the back bezel having a first portion which is formed with a first opening to face at least part of the first high-voltage electrode terminal that has an actual operating temperature lower than the lower-bound temperature.

15. The backlight module of claim 14, wherein each of the linear light source units having a second high-voltage electrode terminal formed at the other end thereof, the back bezel includes a plurality of first openings and a plurality of second openings, in which the first openings are formed to face at least part of the first high-voltage electrode terminals, and the second openings are formed to face at least part of the second high-voltage electrode terminals.

16. The backlight module of claim 14, wherein the back bezel includes a plurality of first openings and a plurality of second openings, in which the first openings are formed to completely face the first high-voltage electrode terminals, and the second openings are formed to completely face the second high-voltage electrode terminals.

17. The backlight module of claim 14, wherein at least one of the linear light source units is an EEFL.

18. The backlight module of claim 14, wherein at least one of the linear light source units is a CCFL.

19. The backlight module of claim 14, wherein at least one of the linear light source units is a flat linear light source.

20. The backlight module of claim 19, wherein the flat linear light source is a CCFFL.
